(19) United States
(12) Patent Application Publication
(10) Pub. No.: US 2024/0329793 A1
(43) Pub. Date: Oct. 3, 2024

(54) TECHNOLOGIES FOR DEVICE MANAGEMENT IN METAVERSE INTERACTIONS

(71) Applicant: Intel Corporation, Santa Clara, CA (US)

(72) Inventors: Aleksander Magi, Portland, OR (US); Glen J. Anderson, Beaverton, OR (US); Arvind Kumar, Beaverton, OR (US); Meng Shi, Hillsboro, OR (US)

(73) Assignee: Intel Corporation, Santa Clara, CA (US)

(21) Appl. No.: 18/129,745

(22) Filed: Mar. 31, 2023

(51) Int. Cl. G06F 3/04815; G06V 10/94

(52) U.S. Cl. CPC G06F 3/04815; G06V 10/945

(57) ABSTRACT

Technologies for device management in metaverse interactions are disclosed. In an illustrative embodiment, a compute device is connected to remote compute devices in a metaverse. The compute device may detect local devices, such as by seeing a device in images captured by a camera of the compute device. The local device may be, e.g., a cell phone or smartwatch. The local devices may be registered by the compute device and reproduced in the metaverse. The local user of the compute device may interface with the local devices in the metaverse. The local user may allow remote users to interface or control the local device as well.

### BACKGROUND

Interactions between users of compute devices may take place in a metaverse. A metaverse can facilitate interactions such as meetings, socializing, and playing games. In physical interactions between people, local devices such as cell phones, tablets, and smartwatches are used as part of physical interactions, such as by one person showing another person a screen of such a device. However, those devices typically are not acknowledged or reproduced in metaverse interactions, limiting individual interactions and collaborative models available in metaverse interactions.

### BRIEF DESCRIPTION OF THE DRAWINGS

FIG. 1 is a simplified block diagram of a system for device management in metaverse interactions.

FIG. 2 is a simplified block diagram of at least one embodiment of a compute device for device management in metaverse interactions.

FIG. 3 is a simplified block diagram of at least one embodiment of an environment that may be established by the compute device of FIG. 1.

FIG. 4 is a simplified block diagram of at least one embodiment of an environment that may be established by a remote compute device of FIG. 1.

FIG. 5 is a simplified block diagram of at least one embodiment of an environment that may be established by a server compute device of FIG. 1.

FIG. 6 is a simplified block diagram of at least one embodiment of an environment that may be established by a local device of FIG. 1.

FIGS. 7-9 are a simplified flow diagram of at least one embodiment of a method for device management in metaverse interactions.

### DETAILED DESCRIPTION

The metaverse is a collective virtual shared space that enables users to interact with a computer-generated environment and with other users in real time. It is a three-dimensional virtual world that can be accessed through various devices, including virtual reality headsets, smartphones, and personal computers. In the metaverse, users can create avatars, explore virtual environments, interact with objects, and engage in social and economic activities. The metaverse has a wide range of potential applications, from gaming and entertainment to education, commerce, and even virtual tourism.

Currently, if a user engaging in a metaverse interaction is using or near secondary screen inputs or peripheral devices like a phone, keyboard, stylus, mouse, audio headset, etc., in the physical world during a metaverse experience, it is not registered or reproduced in the metaverse environment. For example, if a user picks up a cell phone while engaging in a metaverse interaction using a laptop or headset, the cell phone does not appear in the user's hand. As a result, the cell phone is not available to either the user or remote users. In the present disclosure, local devices may be registered and reproduced in the metaverse, allowing interaction and control of local devices by users of the local or remote compute devices. Users may interact with the local device, receive information from the local device, control the local device, etc., as discussed in more detail below.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

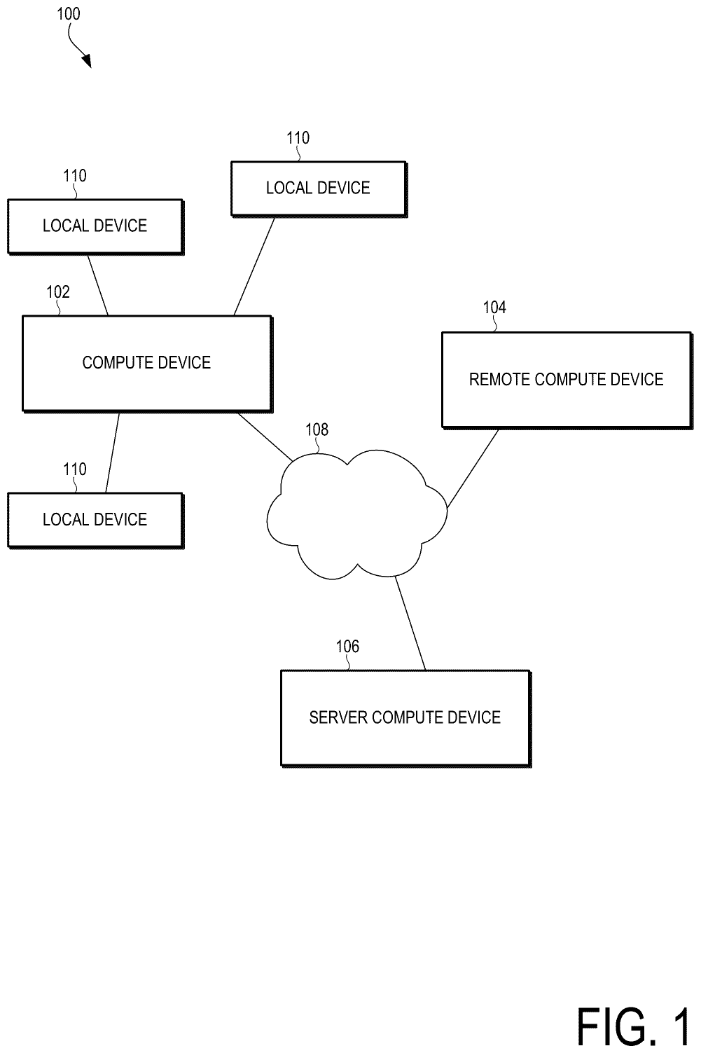

Referring now to FIG. 1, in one embodiment, system 100 for device management in metaverse interactions includes a compute device 102, one or more remote compute devices 104, and one or more server compute devices 106. The compute device 102, the remote compute device 104, and the server compute device 106 are connected by a network 108. One or more local devices 110 may be near the compute device 102.

In use, a user of the compute device 102 may engage in interactions through a metaverse with users of the remote compute device 104. The network 108 and/or the server compute device 106 may be used to facilitate the metaverse and interactions using the metaverse. The compute device 102 may identify nearby available local devices 110, such as by capturing the local devices 110 in images, capturing sounds from the local devices 110 in audio signals, identifying local devices 110 through wireless connections (e.g., Wi-Fi, ultra-wideband, Bluetooth®, etc.), and/or in any other suitable manner. If approved by the user of the compute device 102, the local devices 110 may be reproduced in the metaverse, visible to the user of the compute device 102 and/or the remote compute device 106.

The local devices 110 may be represented in any suitable manner. The local devices 110 may be represented directly, such as using an avatar of the physical device, or indirectly, such as an altered or expanded version of the local device 110. Once represented, the user of the compute device 102 can interact with the local device 110 in the metaverse. For example, the user can provide input to the virtual representation of the local device 110 in the metaverse, and the input may be reflected in the physical local device 110 as well. Conversely, the user can provide input to the physical local device 110, and the input can be represented in the virtual representation of the local device 110 in the metaverse.

In some cases, the user of the compute device 102 may permit a user of the remote compute device 104 to interact with or control the virtual representation of the local device 110. For example, if the local device 110 is a cell phone, the user of the remote compute device 104 may be permitted to scroll through pictures stored on the cell phone 110 through the metaverse. The types of interactions vary widely depending on the type of local device 110 and the applications on the local device 110. Additional examples are presented below.

The compute device and/or the remote compute device 104 may be embodied as, e.g., a laptop computer, a virtual reality headset, an augmented reality headset, a desktop computer, a tablet, and/or the like. The network 108 may be embodied as a local network, the Internet, a cellular network, and/or the like. The server compute device 106 may be embodied as a server computer, a blade computer, an edge node, a cloud computer, etc. The local device 110 may be embodied as any suitable device capable of providing input and/or output, such as a cell phone, a tablet, a laptop, a headset, a keyboard, a mouse, a microphone, a camera, a stylus, etc.

In the illustrative embodiment, the compute device 102 is local or near to the local devices 110, and the remote compute device 106 is remote to the compute device 102 and the local devices 110. However, it should be appreciated that the remote compute device 106 may have corresponding local devices 110 near it that can be reproduced in the metaverse in a similar manner as the local devices 110 near the compute device 102.

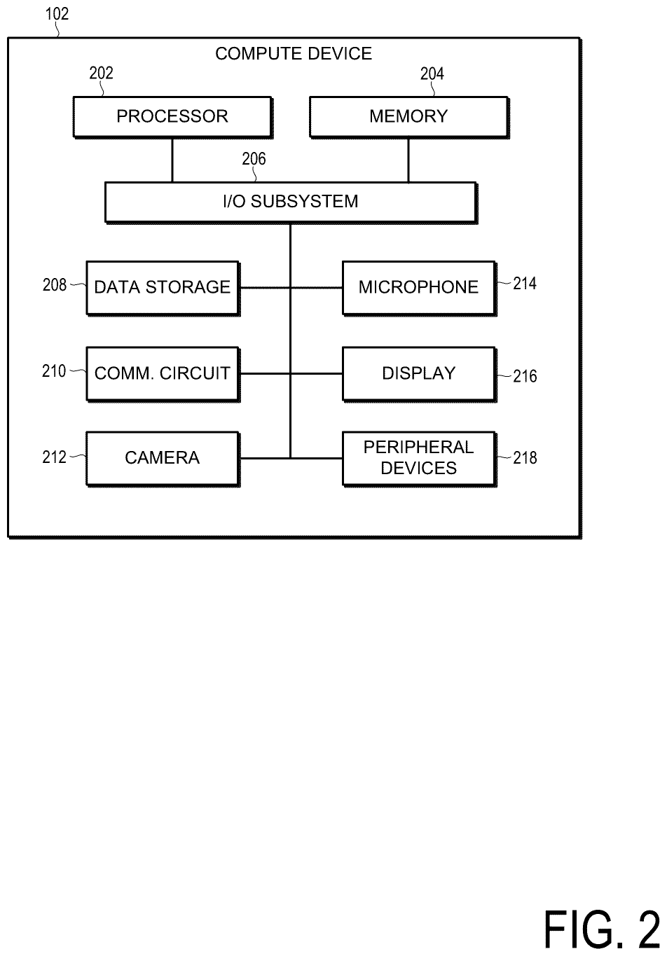

Referring now to FIG. 2, in one embodiment, a compute device 102 for teleconferencing is shown. The compute device 102 may be embodied as any type of compute device. For example, the compute device 102 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a network device, a router, a switch, a networked computer, a wearable computer, a handset, a messaging device, a camera device, and/or any other compute device. In some embodiments, the compute device 102 may be located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that hosts companies' applications and data), and an edge data center (e.g., a data center, typically having a smaller footprint than other data center types, located close to the geographic area that it serves).

The illustrative compute device 102 includes a processor 202, a memory 204, an input/output (I/O) subsystem 206, data storage 208, a communication circuit 210, a camera 212, a microphone 214, a display 216, and one or more peripheral devices 218. In some embodiments, one or more of the illustrative components of the compute device 102 may be incorporated in, or otherwise form a portion of, another component. For example, the memory 204, or portions thereof, may be incorporated in the processor 202 in some embodiments. In some embodiments, one or more of the illustrative components may be physically separated from another component.

The processor 202 may be embodied as any type of processor capable of performing the functions described herein. For example, the processor 202 may be embodied as a single or multi-core processor(s), a single or multi-socket processor, a digital signal processor, a graphics processor, a neural network compute engine, an image processor, a microcontroller, or other processor or processing/controlling circuit. Similarly, the memory 204 may be embodied as any type of volatile or non-volatile memory or data storage capable of performing the functions described herein. In operation, the memory 204 may store various data and software used during operation of the compute device 102, such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the compute device 102. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. The I/O subsystem 206 may connect various internal and external components of the compute device 102 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 206 may form a portion of a system-on-a-chip (SoC) and be incorporated, along with the processor 202, the memory 204, and other components of the compute device 102 on a single integrated circuit chip.

The data storage 208 may be embodied as any type of device or devices configured for the short-term or long-term storage of data. For example, the data storage 208 may include any one or more memory devices and circuits, memory cards, hard disk drives, solid-state drives, or other data storage devices.

The communication circuit 210 may be embodied as any type of interface capable of interfacing the compute device 102 with other compute devices, such as over one or more wired or wireless connections. In some embodiments, the communication circuit 210 may be capable of interfacing with any appropriate cable type, such as an electrical cable or an optical cable. The communication circuit 210 may be configured to use any one or more communication technology and associated protocols (e.g., Ethernet, Bluetooth®, Wi-Fi®, WiMAX, near field communication (NFC), etc.). The communication circuit 210 may be located on silicon separate from the processor 202, or the communication circuit 210 may be included in a multi-chip package with the processor 202, or even on the same die as the processor 202. The communication circuit 210 may be embodied as one or more add-in-boards, daughtercards, network interface cards, controller chips, chipsets, specialized components such as a field-programmable gate array (FPGA) or application-specific integrated circuit (ASIC), or other devices that may be used by the compute device 202 to connect with another compute device. In some embodiments, communication circuit 210 may be embodied as part of a system-on-a-chip (SoC) that includes one or more processors or included on a multichip package that also contains one or more processors. In some embodiments, the communication circuit 210 may include a local processor (not shown) and/or a local memory (not shown) that are both local to the communication circuit 210. In such embodiments, the local processor of the communication circuit 210 may be capable of performing one or more of the functions of the processor 202 described herein. Additionally or alternatively, in such embodiments, the local memory of the communication circuit 210 may be integrated into one or more components of the compute device 202 at the board level, socket level, chip level, and/or other levels.

The camera 212 may be any suitable camera that can capture image or video. The camera 212 may include one or more fixed or adjustable lenses and one or more image sensors. The image sensors may be any suitable type of image sensors, such as a CMOS or CCD image sensor. The camera 212 may have any suitable aperture, focal length, field of view, etc. For example, the camera 212 may have a field of view of 60-110° in the azimuthal and/or elevation directions.

The microphone 214 is configured to sense sound waves and output an electrical signal indicative of the sound waves. In the illustrative embodiment, the compute device 102 may have more than one microphone 214, such as an array of microphones 214 in different positions.

The display 216 may be embodied as any type of display on which information may be displayed to a user of the compute device 102, such as a touchscreen display, a liquid crystal display (LCD), a thin film transistor LCD (TFT-LCD), a light-emitting diode (LED) display, an organic light-emitting diode (OLED) display, a cathode ray tube (CRT) display, a plasma display, an image projector (e.g., 2D or 3D), a laser projector, a heads-up display, and/or other display technology. The display 216 may have any suitable resolution, such as 7680×4320, 3840×2160, 1920×1200, 1920×1080, etc.

In some embodiments, the compute device 102 may include other or additional components, such as those commonly found in a compute device. For example, the compute device 102 may also have peripheral devices 218, such as a keyboard, a mouse, a speaker, an external storage device, a battery, etc. In some embodiments, the compute device 102 may be connected to a dock that can interface with various devices, including peripheral devices 218.

The remote compute device 104, the server compute device 106, and/or the local devices 110 may have similar and/or the same hardware as the compute device 102. A description of that hardware will not be repeated in the interest of clarity. Of course, the particular hardware a device has may depend on the particular embodiment. For example, a server compute device 106 may not include a camera 212 or microphone 214, and a local device 110 may not include a display 216.

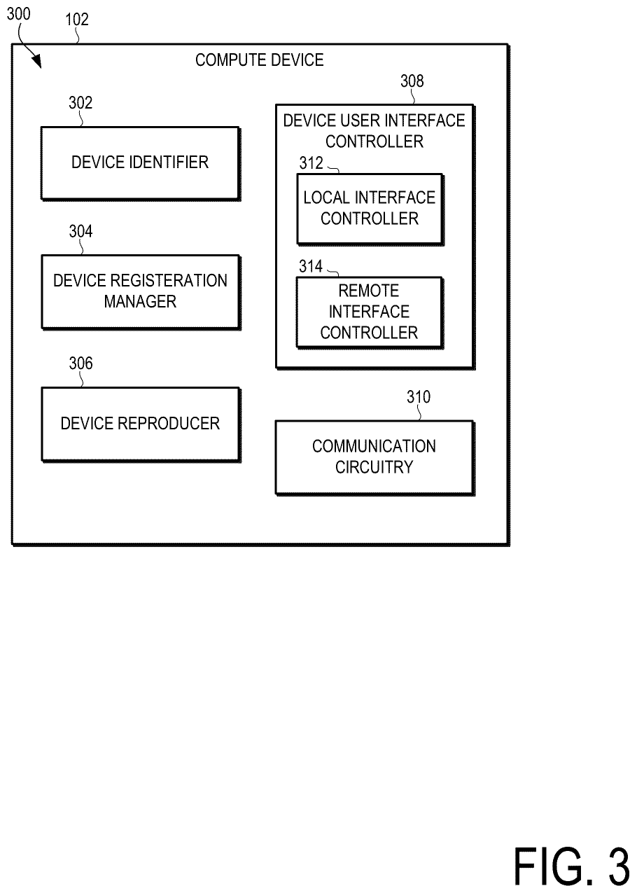

Referring now to FIG. 3, in an illustrative embodiment, the compute device 102 establishes an environment 300 during operation. The illustrative environment 300 includes a device identifier 302, a device registration manager 304, a device reproducer 306, a device user interface controller 308, and communication circuitry 310. The various modules of the environment 300 may be embodied as hardware, software, firmware, or a combination thereof. For example, the various modules, logic, and other components of the environment 300 may form a portion of, or otherwise be established by, the processor 202, the memory 204, the data storage 208, or other hardware components of the compute device 102. As such, in some embodiments, one or more of the modules of the environment 300 may be embodied as circuitry or collection of electrical devices (e.g., device identifier circuitry 302, device registration manager circuitry 304, device reproducer circuitry 306, etc.). It should be appreciated that, in such embodiments, one or more of the circuits (e.g., the device identifier circuitry 302, the device registration manager circuitry 304, the device reproducer circuitry 306, etc.) may form a portion of one or more of the processor 202, the memory 204, the I/O subsystem 206, the data storage 208, and/or other components of the compute device 102. For example, in some embodiments, some or all of the modules may be embodied as the processor 202 as well as the memory 204 and/or data storage 208 storing instructions to be executed by the processor 202. Additionally, in some embodiments, one or more of the illustrative modules may form a portion of another module and/or one or more of the illustrative modules may be independent of one another. Further, in some embodiments, one or more of the modules of the environment 300 may be embodied as virtualized hardware components or emulated architecture, which may be established and maintained by the processor 202 or other components of the compute device 102. It should be appreciated that some of the functionality of one or more of the modules of the environment 300 may require a hardware implementation, in which case embodiments of modules that implement such functionality will be embodied at least partially as hardware.

In the illustrative embodiment, the modules such as the device identifier 302, the device registration manager 304, the device reproducer 306, etc., are part of the compute device 102. Additionally or alternatively, in some embodiments, any suitable module may form part of another device, such as the remote compute device 104 or the server compute device 106. For example, in one embodiment, the server compute device 106 may include the device reproducer 306 that is responsible for determining how the local device 110 is reproduced in the metaverse.

The device identifier 302, which may be embodied as hardware, firmware, software, virtualized hardware, emulated architecture, and/or a combination thereof, as discussed above, is configured to detect one or more local devices 110. The device identifier 302 may process images that include the local device 110. For example, the camera 212 may be used to capture images, such as images that show the user of the compute device 102. The images may include a local device 110. The device identifier 302 may process the images to identify the local device 110. The local device 110 may be, e.g., a phone, a smartwatch, a keyboard, a stylus, a mouse, an audio headset, and/or the like. In other embodiments, the device identifier 302 may detect a local device 110 by processing sound data, such as sound captured by the microphone 214. For example, the device identifier 302 may detect a notification or other sound from a cell phone 110 or smartwatch 110, and detect the local device 110 based on the sound.

In still other embodiments, the device identifier 302 may detect a local device 110 based on a device identifier. A device identifier may be detected in any suitable manner, such as by using Wi-Fi, ultra-wideband, Bluetooth®, etc. More generally, the device identifier 302 may detect local devices 110 in any suitable manner. For example, the device identifier 302 may detect a local device 110 that the user of the compute device 102 interacts with, such as by glancing at, touching, or pointing to the local device 110.

The device registration manager 304, which may be embodied as hardware, firmware, software, virtualized hardware, emulated architecture, and/or a combination thereof, as discussed above, is configured to determine a relationship between the user of the compute device 102 and the local device 110. For example, the device registration manager 304 may determine whether the local device 110 is paired to the compute device 102, is registered to the same user as the compute device 102, has connected to the compute device 102 or the metaverse before, etc. The device registration manager 304 may prompt the user to provide information that can be used to establish a relationship between the local device 110 and the user of the compute device 102, such as a password.

The device registration manager 304 may prompt the user of the compute device 102 to accept registration of the local device 110 and accept that the local device 110 should be reproduced in the metaverse. The user may select that the local device 110 should be ignored or that the local device 110 should be registered and reproduced in the metaverse. Additionally or alternatively, an application running on the compute device 102 and/or the local device 110 control whether or not a local device 110 is registered. The user may also provide parameters for using the local device 110, such as whether the use or representation of the local device 110 is private or available to other users of the metaverse. If the user indicates that the local device 110 should not be registered at this time, the local device 110 may remain available for the user to register or reproduce in the metaverse at a later time.

The device reproducer 306, which may be embodied as hardware, firmware, software, virtualized hardware, emulated architecture, and/or a combination thereof, as discussed above, is configured to reproduce the local device 110 in the metaverse. The device reproducer 306 may reproduce the local device 110 in any suitable manner. The device reproducer 306 may reproduce the local device 110 directly, such as in an avatar that corresponds to the physical form of the local device 110. In such an example, a cell phone 110 of a certain brand, size, model, color, etc., may be represented as a cell phone 110 of that brand, size, model, color, etc. If the local device 110 is a keyboard that the user is typing on, then a keyboard may be reproduced in the metaverse with the user of the compute device 102 typing on it. In another example, the device reproducer 306 may reproduce the local device 110 indirectly, such as in an avatar that differs from the physical form of the local device 110. In such an example, a smartwatch 110 may be represented with a display that is larger, more legible, or more immersive than the actual display of the smartwatch 110. In another example, a device 110 may be represented with a completely unrelated avatar. In such an example, a keyboard that the user is typing on may be represented as an alligator or avatar that produces light rays from fingertips on a table surface.

The device user interface controller 308, which may be embodied as hardware, firmware, software, virtualized hardware, emulated architecture, and/or a combination thereof, as discussed above, is configured to establish a device user interface to interact with the local device 110 in the metaverse. In some cases, the user interface in the metaverse may correspond to the user interface of the physical local device 110. In other cases, the device user interface controller 308 may establish a different user interface. For example, for a smartwatch 110, the user interface in the metaverse may be the same size, have the same form factor, have the same buttons, etc., as the physical smartwatch 110. Additionally or alternatively, the user interface may have, e.g., more or few buttons, buttons in different places, different screen size, different screen shape, etc.

The device user interface controller 308 may control the input to and output from the local device 110. For example, if the local device 110 receives a notification, the device user interface controller 308 may reproduce a notification on the virtual version of the local device 110. For example, a user may receive a text message notification on the display of the physical local device 110. The text message notification may also appear on the display of the virtual local device 110. The notification may appear in a manner other than appearing on the display of the virtual local device 110, such as by generating a unique avatar from the virtual local device 110 that can act as an interactive delivery character. Depending on the notification, application settings, privacy settings, etc., certain notifications may only be visible to the user of the compute device 102. In some embodiments, a notification may be shown on the local device 110 when the user glances either at the physical local device 110 or at the virtual reproduction of the local device 110. In other embodiments, the user's intent may trigger a notification or other action, such as a user's touch or pointing at the physical or virtual local device 110.

The device user interface controller 308 includes a local interface controller 312 to allow the local user to interface with the local device 110 and a remote interface controller 314 to remote users to interface with the local device. If the user of the compute device 102 interacts with the physical local device 110, then the local interface controller 312 may reproduce the interaction in the metaverse. For example, if the user picks up the physical local device 110, the avatar of the user in the metaverse may pick up the virtual local device 110 in the metaverse. In another example, the user may turn a cell phone over, hiding the display 216. In response, the local interface controller 312 may disable the display 216 of the virtual reproduction of the local device 110. If the user provides an input or triggers an output on the physical local device 110, the local interface controller 312 may reproduce the input or output on the virtual local device 110 in the metaverse.

Similarly, if the user interacts with the virtual local device 110 in the metaverse, the local interface controller 312 may reproduce the interaction in the physical local device 110. For example, if the user provides an input or triggers an output on the virtual local device 110 in the metaverse, the local interface controller 312 may reproduce the input or output on the physical local device 110. The user may be able to interact with the virtual local device 110 to do any suitable task. For example, the user may be able to provide input and/or receive output, change settings, control hardware such as the camera 212 or the microphone 214, install applications, open applications, send messages, save a file, edit a file, create a file, and/or any other suitable task.

The remote interface controller 314 is configured to allow access to the user interface of the virtual local device 110 by remote users. The user of the compute device 102 may indicate that control should be passed to another user in the metaverse, such as a user of the remote compute device 102. For example, the user may make a selection to pass control to the other user, or the user may otherwise make such an indication, such as by passing the virtual local device 110 to another user in the metaverse.

Depending on the level of access granted, the remote interface controller 314 may allow the remote user to view the display of the local device 110, scroll through text or images, launch applications, navigate applications, send messages such as texts or emails, control peripherals such as the camera 212 or microphone 214, etc.

The remote interface controller 314 may allow the local device 110 to receive an input from the remote user. For example, the remote user may provide text input, save a file, edit a file, record video or audio, etc. If the local user of the compute device 102 accepts the input from the remote user, the remote interface controller 314 may save the input from the remote user. For example, text provided by the user may be saved or displayed on the local device, a file may be saved, edited, deleted, etc. If the local user of the compute device 102 does not accept the input from the remote user, the remote interface controller 314 may discard the input from the remote user.

The communication circuitry 310 is configured to communicate with other compute devices. The communication circuitry 310 may implement any suitable protocols, such as Wi-Fi, Ethernet, IP, TCP, UDP, RTP, etc. The communication circuitry 310 may be used to connect to a metaverse, such as by connecting to the server compute device 106.

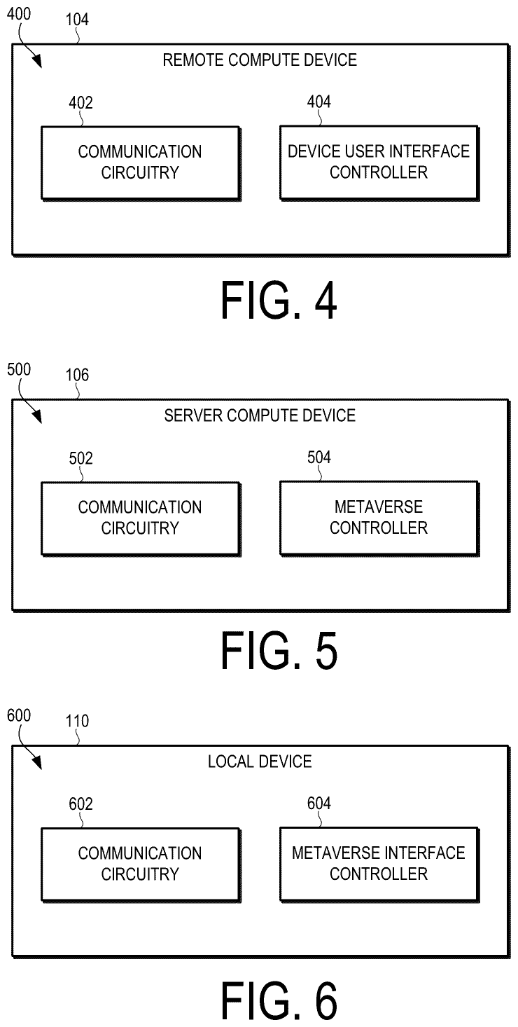

Referring now to FIG. 4, in an illustrative embodiment, the remote compute device 104 establishes an environment 400 during operation. The illustrative environment 400 includes communication circuitry 402 and a device user interface controller 404. The various modules of the environment 400 may be embodied as hardware, software, firmware, or a combination thereof. For example, the various modules, logic, and other components of the environment 400 may form a portion of, or otherwise be established by, the processor, the memory, the data storage, or other hardware components of the remote compute device 104. As such, in some embodiments, one or more of the modules of the environment 400 may be embodied as circuitry or collection of electrical devices (e.g., communication circuitry 402, device user interface controller circuitry 404, etc.). It should be appreciated that, in such embodiments, one or more of the circuits (e.g., the communication circuitry 402, the device user interface controller circuitry 404, etc.) may form a portion of one or more of the processor, the memory, the I/O subsystem, the data storage, and/or other components of the remote compute device 104. For example, in some embodiments, some or all of the modules may be embodied as the processor as well as the memory and/or data storage storing instructions to be executed by the processor. Additionally, in some embodiments, one or more of the illustrative modules may form a portion of another module and/or one or more of the illustrative modules may be independent of one another. Further, in some embodiments, one or more of the modules of the environment 400 may be embodied as virtualized hardware components or emulated architecture, which may be established and maintained by the processor or other components of the remote compute device 104. It should be appreciated that some of the functionality of one or more of the modules of the environment 400 may require a hardware implementation, in which case embodiments of modules that implement such functionality will be embodied at least partially as hardware.

The communication circuitry 402 is configured to communicate with other compute devices. The communication circuitry 402 may implement any suitable protocols, such as Wi-Fi, Ethernet, IP, TCP, UDP, RTP, etc. The communication circuitry 402 may be used to connect to a metaverse, such as by connecting to the server compute device 106.

The device user interface controller 404, which may be embodied as hardware, firmware, software, virtualized hardware, emulated architecture, and/or a combination thereof, as discussed above, is configured to interface with a local device 110 that is connected to the metaverse by the user of the compute device 102. The device user interface controller 404 may allow the user of the remote compute device 102 to see and/or interact with the local device 110 in the metaverse. The device user interface controller 404 may receive indications from the compute device 102 and/or the server compute device 106 regarding how and to what extent the remote compute device 104 can interact with and/or control the local device 110. For example, in some cases, a local device 110 may be present in the metaverse for the user of the compute device 102, but the device user interface controller 404 may not be able to make the local device 110 visible in the metaverse for the user of the remote compute device 104. After receiving appropriate permission, the device user interface controller 404 may reproduce the local device 110 in the metaverse for the user of the remote compute device 104. The device user interface controller 404 may reproduce the local device 110 using any suitable user interface, similar to the possible user interfaces described above in regard to the device user interface controller 308.

The device user interface controller 404 may present output from the local device 110 in the metaverse in a manner that is visible to the user of the remote compute device 104. For example, a notification may appear on the display of the local device 110. In some cases, the user of the remote compute device 104 may be granted access to provide input to or otherwise control the local device 110. For example, the device user interface controller 404 may be able to accept input from the user of the remote compute device 104 and provide it to the local device 110.

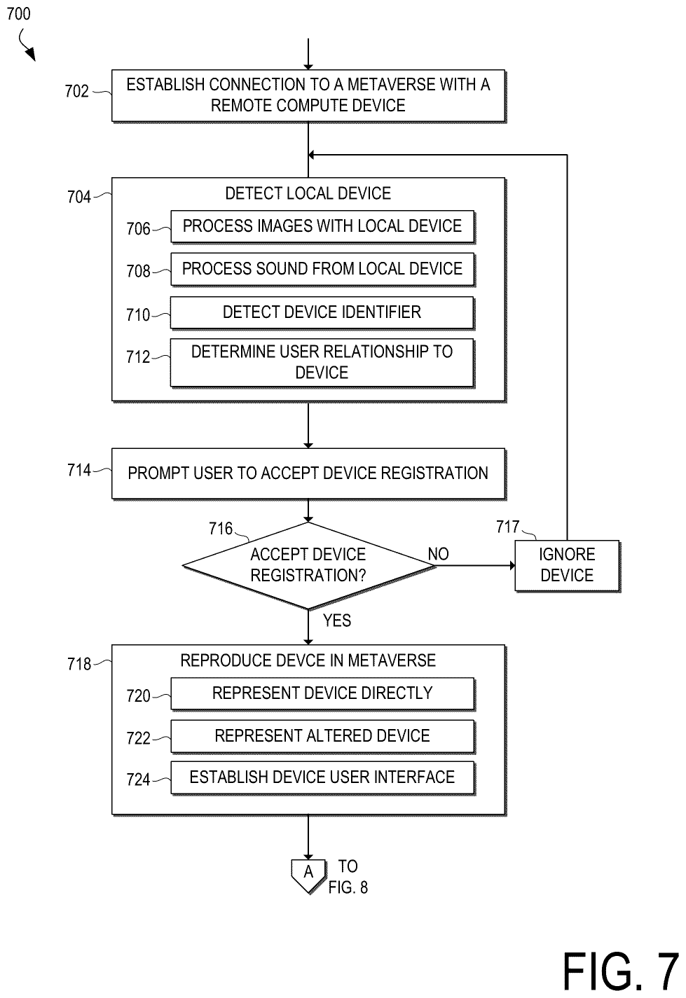

Referring now to FIG. 5, in an illustrative embodiment, the server compute device 106 establishes an environment 500 during operation. The illustrative environment 500 includes communication circuitry 502 and a metaverse controller 504. The various modules of the environment 500 may be embodied as hardware, software, firmware, or a combination thereof. For example, the various modules, logic, and other components of the environment 500 may form a portion of, or otherwise be established by, the processor, the memory, the data storage, or other hardware components of the server compute device 106. As such, in some embodiments, one or more of the modules of the environment 500 may be embodied as circuitry or collection of electrical devices (e.g., communication circuitry 502, metaverse controller 504, etc.). It should be appreciated that, in such embodiments, one or more of the circuits (e.g., the communication circuitry 502, the metaverse controller 504, etc.) may form a portion of one or more of the processor, the memory, the I/O subsystem, the data storage, and/or other components of the server compute device 106. For example, in some embodiments, some or all of the modules may be embodied as the processor as well as the memory and/or data storage storing instructions to be executed by the processor. Additionally, in some embodiments, one or more of the illustrative modules may form a portion of another module and/or one or more of the illustrative modules may be independent of one another. Further, in some embodiments, one or more of the modules of the environment 500 may be embodied as virtualized hardware components or emulated architecture, which may be established and maintained by the processor or other components of the server compute device 106. It should be appreciated that some of the functionality of one or more of the modules of the environment 500 may require a hardware implementation, in which case embodiments of modules that implement such functionality will be embodied at least partially as hardware.

The communication circuitry 502 is configured to communicate with other compute devices. The communication circuitry 502 may implement any suitable protocols, such as Wi-Fi, Ethernet, IP, TCP, UDP, RTP, etc. The communication circuitry 502 may be used to facilitate other compute devices to connect to a metaverse that is at least partially managed by the server compute device 106.

The metaverse controller 504, which may be embodied as hardware, firmware, software, virtualized hardware, emulated architecture, and/or a combination thereof, as discussed above, is configured to establish and manage a metaverse that other compute devices can connect to, such as the compute device 102 and the remote compute device 106.

The metaverse controller 504 is also configured to facilitate reproduction of local devices 110 in the metaverse. The metaverse controller 504 may manage reproduction of local devices 110 itself, or the metaverse controller 504 may allow the compute device 110 to manage reproduction of local devices 110 in the metaverse. In some embodiments, the metaverse controller 504 may manage the virtual reproduction of the local device 110, such as by operating a virtual machine corresponding to the local device 110. Additionally or alternatively, the metaverse controller 504 may communicate with the local device 110 to provide input to and output from the local device 110 based on interactions with the local device 110 in the metaverse.

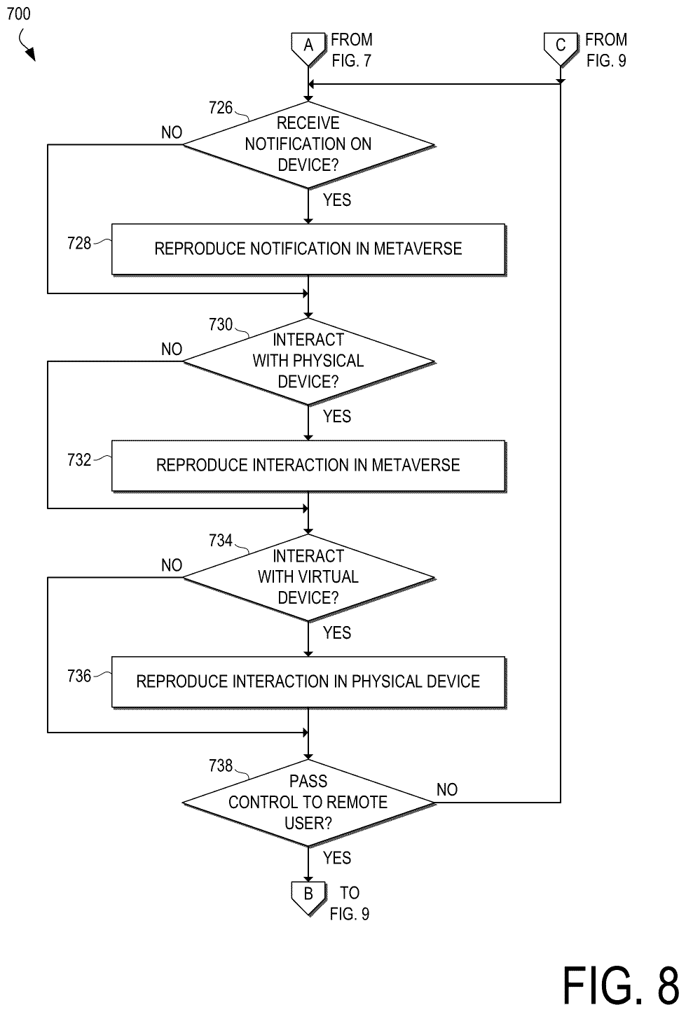

Referring now to FIG. 6, in an illustrative embodiment, the local device 110 establishes an environment 600 during operation. The illustrative environment 500 includes communication circuitry 602 and a metaverse interface controller 604. The various modules of the environment 600 may be embodied as hardware, software, firmware, or a combination thereof. For example, the various modules, logic, and other components of the environment 600 may form a portion of, or otherwise be established by, the processor, the memory, the data storage, or other hardware components of the local device 110. As such, in some embodiments, one or more of the modules of the environment 600 may be embodied as circuitry or collection of electrical devices (e.g., communication circuitry 602, metaverse interface controller 604, etc.). It should be appreciated that, in such embodiments, one or more of the circuits (e.g., the communication circuitry 602, the metaverse interface controller 604, etc.) may form a portion of one or more of the processor, the memory, the I/O subsystem, the data storage, and/or other components of the local device 110. For example, in some embodiments, some or all of the modules may be embodied as the processor as well as the memory and/or data storage storing instructions to be executed by the processor. Additionally, in some embodiments, one or more of the illustrative modules may form a portion of another module and/or one or more of the illustrative modules may be independent of one another. Further, in some embodiments, one or more of the modules of the environment 600 may be embodied as virtualized hardware components or emulated architecture, which may be established and maintained by the processor or other components of the local device 110. It should be appreciated that some of the functionality of one or more of the modules of the environment 600 may require a hardware implementation, in which case embodiments of modules that implement such functionality will be embodied at least partially as hardware.

The communication circuitry 602 is configured to communicate with other compute devices. The communication circuitry 602 may implement any suitable protocols, such as Wi-Fi, Ethernet, IP, TCP, UDP, RTP, etc. The communication circuitry 602 may be used to facilitate the local device 110 to communicate with the compute device 102. The communication circuitry 602 may also be used to facilitate the reproduction of the local device 110 in the metaverse managed by the server compute device 106.

The metaverse interface controller 604, which may be embodied as hardware, firmware, software, virtualized hardware, emulated architecture, and/or a combination thereof, as discussed above, is configured to allow the local device 110 to connect to the metaverse. The metaverse interface controller 604 can be used to detect and register the local device 110 with the compute device 102. The metaverse interface controller 604 may facilitate reproduction of the local device 110 in the metaverse, such as by providing configuration information, user interface information, hardware parameters, etc., to the compute device 102 and/or the server compute device 106 to be used in reproducing the local device 110.

In some embodiments, when users interface with the virtual reproduction of the local device 110 in the metaverse, the metaverse interface controller 604 processes inputs from and provides outputs to users. The metaverse interface controller 604 may send and receive data, such as text data, image data, video data, executable data, etc., as part of the interaction with the metaverse. In some embodiments, functions of the local device 110 may be simulated or virtually replicated by another compute device, such as the server compute device 106, while the local device 110 is reproduced in the metaverse. In such an embodiment, the metaverse interface controller 604 may facilitate synchronization to ensure that any changes made in the virtual local device 110 are properly reflected in the physical local device 110.

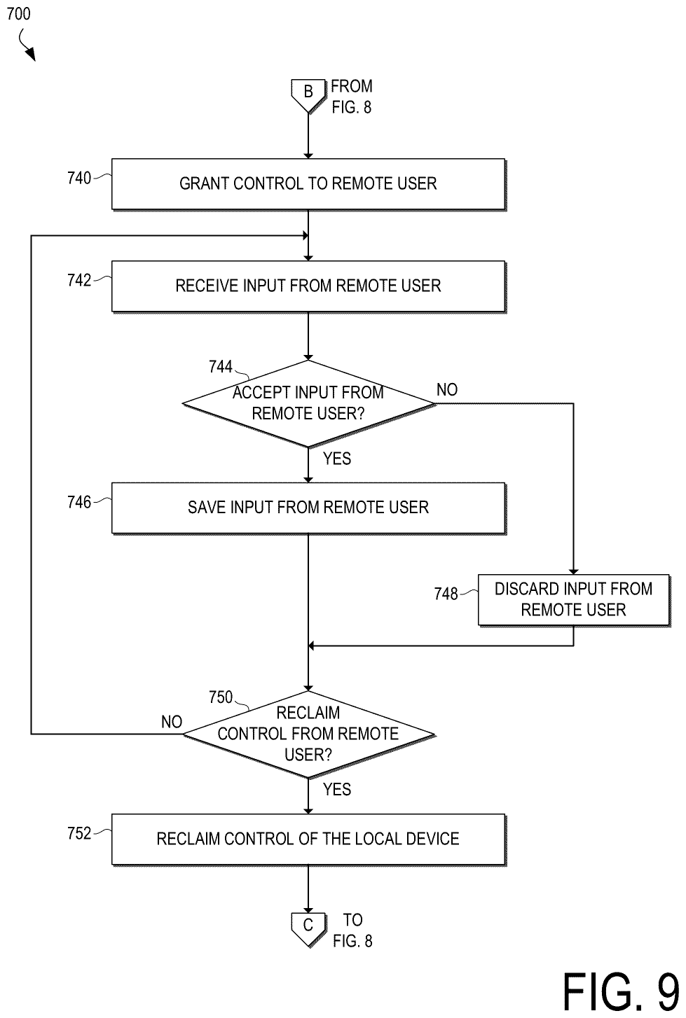

Referring now to FIG. 7, in use, the compute device 102 may execute a method 700 for device management in metaverse interactions. It should be appreciated that, in some embodiments, various aspects of the method 700 may be performed by any suitable combination of compute devices 102, 104, 106. For example, when a local device 110 is reproduced in the metaverse, the avatar representing the local device 110 may be created by the compute device 102, the server compute device 106, and/or the remote compute device 104. As another example, users may interface with the virtual representation of the local device 110, such as launching or interfacing with applications. Depending on the embodiment and/or the application, the applications may be operated on the local device 110, the compute device 102, the remote compute device 104, and/or the server compute device 106. More generally, any suitable computing task discussed below in regard to the method 700 may be performed by any suitable combination of the compute devices 102, 104, 106.

The method 700 begins in block 702, in which the compute device 102 establishes a connection with a metaverse that is also connected to one or more remote compute devices 104. The compute device 102 may connect to the metaverse through one or more server compute devices 106, such as one or more cloud compute devices 106. The compute device 102 connecting to the metaverse may be, e.g., a laptop, a headset, a cell phone, etc.

In block 704, the compute device 102 detects one or more local devices 110. The compute device 102 may process images that include the local device 110 in block 706. For example, the camera 212 may be used to capture images, such as images that show the user of the compute device 102. The images may include a local device 110. The compute device 102 may process the images to identify the local device 110. The local device 110 may be, e.g., a phone, a smartwatch, a keyboard, a stylus, a mouse, an audio headset, and/or the like.

In block 708, the compute device 102 may detect a local device 110 by processing sound data, such as sound captured by the microphone 214. For example, the compute device 102 may detect a notification or other sound from a cell phone 110 or smartwatch 110, and detect the local device 110 based on the sound.

In block 710, the compute device 102 may detect a local device 110 based on a device identifier. A device identifier may be detected in any suitable manner, such as by using Wi-Fi, ultra-wideband, Bluetooth®, etc.

In other embodiments, the compute device 102 may detect local devices 110 in any suitable manner. For example, the compute device 102 may detect a local device 110 that the user of the compute device 102 interacts with, such as by glancing at, touching, or pointing to the local device 110.

In block 712, the compute device 102 may determine a relationship between the user of the compute device 102 and the local device 110. For example, the compute device 102 may determine whether the local device 110 is paired to the compute device 102, is registered to the same user as the compute device 102, has connected to the compute device 102 or the metaverse before, etc. The compute device 102 may prompt the user to provide information that can be used to establish a relationship between the local device 110 and the user of the compute device 102, such as a password.

In block 714, the compute device 102 may prompt the user of the compute device 102 to accept registration of the local device 110 and accept that the local device 110 should be reproduced in the metaverse. The user may select that the local device 110 should be ignored or that the local device 110 should be registered and reproduced in the metaverse. Additionally or alternatively, an application running on the compute device 102 and/or the local device 110 control whether or not a local device 110 is registered. The user may also provide parameters for using the local device 110, such as whether the use or representation of the local device 110 is private or available to other users of the metaverse.

In block 716, if the user indicates that the local device 110 should be ignored, the method proceeds to block 717, in which the compute device 102 ignores the local device 110. The local device 110 may remain available for the user to register or reproduce in the metaverse at a late time. The method 700 then loops back to block 704 to continue detecting local devices 110.

Referring back to block 716, if the user indicates that registration of the local device 110 should be accepted, the method 700 proceeds to block 718, in which the local device 110 is reproduced in the metaverse. The local device 110 may be reproduced in any suitable manner. For example, in block 720, the local device 110 may be reproduced directly, such as in an avatar that corresponds to the physical form of the local device 110. In such an example, a cell phone 110 of a certain brand, size, model, color, etc., may be represented as a cell phone 110 of that brand, size, model, color, etc. If the local device 110 is a keyboard that the user is typing on, then a keyboard may be reproduced in the metaverse with the user of the compute device 102 typing on it. In another example, in block 722, the local device 110 may be reproduced indirectly, such as in an avatar that differs from the physical form of the local device 110. In such an example, a smartwatch 110 may be represented with a display that is larger, more legible, or more immersive than the actual display of the smartwatch 110. In another example, a device 110 may be represented with a completely unrelated avatar. In such an example, a keyboard that the user is typing on may be represented as an alligator or avatar that produces light rays from fingertips on a table surface.

In block 724, for some local devices 110, a device user interface may be established. In some cases, the user interface in the metaverse may correspond to the user interface of the physical local device 110. In other cases, a different user interface may be established. For example, for a smartwatch 110, the user interface in the metaverse may be the same size, have the same form factor, have the same buttons, etc., as the physical smartwatch 110. Additionally or alternatively, the user interface may have, e.g., more or few buttons, buttons in different places, different screen size, different screen shape, etc.

Referring now to FIG. 7, in block 726, if the local device 110 receives a notification, the method 700 proceeds to block 728, in which a notification is reproduced on the virtual version of the local device 110. For example, a user may receive a text message notification on the display of the physical local device 110. The text message notification may also appear on the display of the virtual local device 110. The notification may appear in a manner other than appearing on the display of the virtual local device 110, such as by generating a unique avatar from the virtual local device 110 that can act as an interactive delivery character. Depending on the notification, application settings, privacy settings, etc., certain notifications may only be visible to the user of the compute device 102. In some embodiments, a notification may be shown on the local device 110 when the user glances either at the physical local device 110 or at the virtual reproduction of the local device 110. In other embodiments, user's intent may trigger a notification or other action, such as a user's touch or pointing at the physical or virtual local device 110.

In block 730, if the user interacts with the physical local device 110, then the interaction may be reproduced in the metaverse in block 732. For example, if the user picks up the physical local device 110, the avatar of the user in the metaverse may pick up the virtual local device 110 in the metaverse. In another example, the user may turn a cell phone over, hiding the display 216. In response, the virtual reproduction of the local device 110 may have its display 216 disabled or have notifications disabled. If the user provides an input or triggers an output on the physical local device 110, the input or output may be reproduced on the virtual local device 110 in the metaverse.

In block 734, if the user interacts with the virtual local device 110 in the metaverse, the interaction may be reproduced in the physical local device in block 736. For example, if the user provides an input or triggers an output on the virtual local device 110 in the metaverse, the input or output may be reproduced on the physical local device 110. The user may be able to interact with the virtual local device 110 to do any suitable task. For example, the user may be able to provide input and/or receive output, change settings, control hardware such as the camera 212 or the microphone 214, install applications, open applications, send messages, save a file, edit a file, create a file, and/or any other suitable task.

In block 738, the user of the local device 110 may indicate that control should be passed to another user in the metaverse, such as a user of the remote compute device 102. For example, the user may make a selection to pass control to the other user, or the user may otherwise make such an indication, such as by passing the virtual local device 110 to another user in the metaverse. If the user does not make such an indication, the method 700 loops back to block 726 to check for other interactions, such as notifications from the local device 110. If the user does make such an indication, the method 700 proceeds to block 740 in FIG. 8.

Referring now to FIG. 8, in block 740, control of the local device 110 is granted to another user in the metaverse, such as a user of the remote compute device 104. Depending on the level of access granted, the remote user may be able to view the display of the local device 110, scroll through text or images, launch applications, navigate applications, send messages such as texts or emails, control peripherals such as the camera 212 or microphone 214, etc.

In block 742, an input is received from the remote user. For example, the remote user may provide text input, save a file, edit a file, record video or audio, etc. In block 744, if the local user of the compute device 102 accepts the input from the remote user, the method 700 proceeds to block 746, in which the input from the remote user is saved. For example, text provided by the user may be saved or displayed on the local device, a file may be saved, edited, deleted, etc. If the local user of the compute device 102 does not accept the input from the remote user, the method 700 proceeds to block 748, in which the input from the remote user is discarded.

In block 750, if the user of the compute device 102 does not reclaim control of the local device 110, the method 700 loops back to block 742 to continue accepting input from the remote user. If the user of the compute device 102 does reclaim control of the local device 110, the method 700 proceeds to block 752, in which control of the local device 110 is reclaimed by the user of the compute device 102. The method 700 then jumps back block 726 in FIG. 7 to check for other interactions, such as notifications from the local device 110.

### EXAMPLES

Illustrative examples of the technologies disclosed herein are provided below. An embodiment of the technologies may include any one or more, and any combination of, the examples described below.

Example 1 includes a compute device comprising a processor; a memory coupled to the processor comprising a plurality of instructions that, when executed by the processor, cause the compute device to establish a connection to a metaverse, wherein one or more remote compute devices are connected to the metaverse; detect a local device that is local to the compute device; facilitate a reproduction of the local device in the metaverse; and facilitate interaction with the reproduction of the local device through the metaverse.

Example 2 includes the subject matter of Example 1, and wherein to detect the local device comprises to capture an image of the local device; and process the image to identify the local device in the image.

Example 3 includes the subject matter of any of Examples 1 and 2, and wherein to detect the local device comprises to capture sound data emitted from of the local device; and process the sound data to identify the local device.

Example 4 includes the subject matter of any of Examples 1-3, and wherein to detect the local device comprises to detect the local device over a wireless signal.

Example 5 includes the subject matter of any of Examples 1-4, and wherein the plurality of instructions further cause the compute device to prompt, in response to detection of the local device, a user of the compute device to accept the local device for reproduction in the metaverse.

Example 6 includes the subject matter of any of Examples 1-5, and wherein the local device has a form factor, wherein to facilitate the reproduction of the local device in the metaverse comprises to facilitate the reproduction of the local device with the form factor.

Example 7 includes the subject matter of any of Examples 1-6, and wherein the local device has a form factor, wherein to facilitate the reproduction of the local device in the metaverse comprises to facilitate the reproduction of the local device with a second form factor different from the form factor.

Example 8 includes the subject matter of any of Examples 1-7, and wherein the local device is a cell phone or a smart watch.

Example 9 includes the subject matter of any of Examples 1-8, and wherein the local device is a stylus, a keyboard, or a mouse.

Example 10 includes the subject matter of any of Examples 1-9, and wherein the local device has a user interface, wherein the plurality of instructions further cause the compute device to facilitate establishment of a user interface for the reproduction of the local device in the metaverse, wherein the user interface for the reproduction of the local device corresponds to the user interface of the local device.

Example 11 includes the subject matter of any of Examples 1-10, and wherein the local device has a user interface, wherein the plurality of instructions further cause the compute device to facilitate establishment of a user interface for the reproduction of the local device in the metaverse, wherein the user interface for the reproduction of the local device corresponds to a modification of the user interface of the local device.

Example 12 includes the subject matter of any of Examples 1-11, and wherein the plurality of instructions further cause the compute device to in response to receipt of a notification by the local device, facilitate reproduction of the notification on the reproduction of the local device in the metaverse.

Example 13 includes the subject matter of any of Examples 1-12, and wherein the plurality of instructions further cause the compute device to receive an input provided by a user of the compute device to the reproduction of the local device in the metaverse; and facilitate reproduction of the input on the local device.

Example 14 includes the subject matter of any of Examples 1-13, and wherein the plurality of instructions further cause the compute device to in response to receipt of an input to the local device, facilitate reproduction of the input on the reproduction of the local device in the metaverse.

Example 15 includes the subject matter of any of Examples 1-14, and wherein the plurality of instructions further cause the compute device to receive, from a user of the compute device, an indication that control of the reproduction of the local device in the metaverse is permitted by the one or more remote compute devices.

Example 16 includes the subject matter of any of Examples 1-15, and wherein the plurality of instructions further cause the compute device to receive an input to the reproduction of the local device in the metaverse from the one or more remote compute devices; and determine whether to pass the input to the reproduction of the local device.

Example 17 includes a method comprising establishing, by a compute device, a connection to a metaverse, wherein one or more remote compute devices are connected to the metaverse; detecting, by the compute device, a local device that is local to the compute device; facilitating, by the compute device, a reproduction of the local device in the metaverse; and facilitating, by the compute device, interaction with the reproduction of the local device through the metaverse.

Example 18 includes the subject matter of Example 17, and wherein detecting the local device comprises capturing, by the compute device, an image of the local device; and processing, by the compute device, the image to identify the local device in the image.

Example 19 includes the subject matter of any of Examples 17 and 18, and wherein detecting the local device comprises capturing, by the compute device, sound data emitted from of the local device; and processing, by the compute device, the sound data to identify the local device.

Example 20 includes the subject matter of any of Examples 17-19, and wherein detecting the local device comprises detecting the local device over a wireless signal.

Example 21 includes the subject matter of any of Examples 17-20, and further including prompting, by the compute device and in response to detecting the local device, a user of the compute device to accept the local device for reproduction in the metaverse.

Example 22 includes the subject matter of any of Examples 17-21, and wherein the local device has a form factor, wherein facilitating the reproduction of the local device in the metaverse comprises facilitating the reproduction of the local device with the form factor.

Example 23 includes the subject matter of any of Examples 17-22, and wherein the local device has a form factor, wherein facilitating the reproduction of the local device in the metaverse comprises facilitating the reproduction of the local device with a second form factor different from the form factor.

Example 24 includes the subject matter of any of Examples 17-23, and wherein the local device is a cell phone or a smart watch.

Example 25 includes the subject matter of any of Examples 17-24, and wherein the local device is a stylus, a keyboard, or a mouse.

Example 26 includes the subject matter of any of Examples 17-25, and wherein the local device has a user interface, further comprising facilitating establishment of a user interface for the reproduction of the local device in the metaverse, wherein the user interface for the reproduction of the local device corresponds to the user interface of the local device.

Example 27 includes the subject matter of any of Examples 17-26, and wherein the local device has a user interface, further comprising facilitating establishment of a user interface for the reproduction of the local device in the metaverse, wherein the user interface for the reproduction of the local device corresponds to a modification of the user interface of the local device.

Example 28 includes the subject matter of any of Examples 17-27, and further including in response to receipt of a notification by the local device, facilitating, by the compute device, reproduction of the notification on the reproduction of the local device in the metaverse.

Example 29 includes the subject matter of any of Examples 17-28, and further including receiving, by the compute device, an input provided by a user of the compute device to the reproduction of the local device in the metaverse; and facilitating, by the compute device, reproduction of the input on the local device.

Example 30 includes the subject matter of any of Examples 17-29, and further including in response to receipt of an input to the local device, facilitating, by the compute device, reproduction of the input on the reproduction of the local device in the metaverse.

Example 31 includes the subject matter of any of Examples 17-30, and further including receiving, by the compute device and from a user of the compute device, an indication that control of the reproduction of the local device in the metaverse is permitted by the one or more remote compute devices.

Example 32 includes the subject matter of any of Examples 17-31, and further including receiving, by the compute device, an input to the reproduction of the local device in the metaverse from the one or more remote compute devices; and determining, by the compute device, whether to pass the input to the reproduction of the local device.

Example 33 includes a compute device comprising means for establishing a connection to a metaverse, wherein one or more remote compute devices are connected to the metaverse; means for detecting a local device that is local to the compute device; means for facilitating a reproduction of the local device in the metaverse; and means for facilitating interaction with the reproduction of the local device through the metaverse.

Example 34 includes the subject matter of Example 33, and wherein the means for detecting the local device comprises means for capturing an image of the local device; and means for processing the image to identify the local device in the image.

Example 35 includes the subject matter of any of Examples 33 and 34, and wherein the means for detecting the local device comprises means for capturing sound data emitted from of the local device; and means for processing the sound data to identify the local device.

Example 36 includes the subject matter of any of Examples 33-35, and wherein the means for detecting the local device comprises means for detecting the local device over a wireless signal.

Example 37 includes the subject matter of any of Examples 33-36, and further including means for prompting, in response to detecting the local device, a user of the compute device to accept the local device for reproduction in the metaverse.

Example 38 includes the subject matter of any of Examples 33-37, and wherein the local device has a form factor, wherein the means for facilitating the reproduction of the local device in the metaverse comprises means for facilitating the reproduction of the local device with the form factor.

Example 39 includes the subject matter of any of Examples 33-38, and wherein the local device has a form factor, wherein the means for facilitating the reproduction of the local device in the metaverse comprises means for facilitating the reproduction of the local device with a second form factor different from the form factor.

Example 40 includes the subject matter of any of Examples 33-39, and wherein the local device is a cell phone or a smart watch.

Example 41 includes the subject matter of any of Examples 33-40, and wherein the local device is a stylus, a keyboard, or a mouse.

Example 42 includes the subject matter of any of Examples 33-41, and wherein the local device has a user interface, further comprising means for facilitating establishment of a user interface for the reproduction of the local device in the metaverse, wherein the user interface for the reproduction of the local device corresponds to the user interface of the local device.

Example 43 includes the subject matter of any of Examples 33-42, and wherein the local device has a user interface, further comprising means for facilitating establishment of a user interface for the reproduction of the local device in the metaverse, wherein the user interface for the reproduction of the local device corresponds to a modification of the user interface of the local device.

Example 44 includes the subject matter of any of Examples 33-43, and further including in response to receipt of a notification by the local device, facilitating reproduction of the notification on the reproduction of the local device in the metaverse.

Example 45 includes the subject matter of any of Examples 33-44, and further including means for receiving an input provided by a user of the compute device to the reproduction of the local device in the metaverse; and means for facilitating reproduction of the input on the local device.

Example 46 includes the subject matter of any of Examples 33-45, and further including in response to receipt of an input to the local device, facilitating reproduction of the input on the reproduction of the local device in the metaverse.

Example 47 includes the subject matter of any of Examples 33-46, and further including means for receiving, from a user of the compute device, an indication that control of the reproduction of the local device in the metaverse is permitted by the one or more remote compute devices.

Example 48 includes the subject matter of any of Examples 33-47, and further including means for receiving an input to the reproduction of the local device in the metaverse from the one or more remote compute devices; and means for determining whether to pass the input to the reproduction of the local device.

Example 49 includes one or more computer-readable media comprising a plurality of instructions stored thereon that, when executed, causes a compute device to establish a connection to a metaverse, wherein one or more remote compute devices are connected to the metaverse; detect a local device that is local to the compute device; facilitate a reproduction of the local device in the metaverse; and facilitate interaction with the reproduction of the local device through the metaverse.

Example 50 includes the subject matter of Example 49, and wherein to detect the local device comprises to capture an image of the local device; and process the image to identify the local device in the image.

Example 51 includes the subject matter of any of Examples 49 and 50, and wherein to detect the local device comprises to capture sound data emitted from of the local device; and process the sound data to identify the local device.

Example 52 includes the subject matter of any of Examples 49-51, and wherein to detect the local device comprises to detect the local device over a wireless signal.

Example 53 includes the subject matter of any of Examples 49-52, and wherein the plurality of instructions further cause the compute device to prompt, in response to detection of the local device, a user of the compute device to accept the local device for reproduction in the metaverse.

Example 54 includes the subject matter of any of Examples 49-53, and wherein the local device has a form factor, wherein to facilitate the reproduction of the local device in the metaverse comprises to facilitate the reproduction of the local device with the form factor.

Example 55 includes the subject matter of any of Examples 49-54, and wherein the local device has a form factor, wherein to facilitate the reproduction of the local device in the metaverse comprises to facilitate the reproduction of the local device with a second form factor different from the form factor.

Example 56 includes the subject matter of any of Examples 49-55, and wherein the local device is a cell phone or a smart watch.

Example 57 includes the subject matter of any of Examples 49-56, and wherein the local device is a stylus, a keyboard, or a mouse.

Example 58 includes the subject matter of any of Examples 49-57, and wherein the local device has a user interface, wherein the plurality of instructions further cause the compute device to facilitate establishment of a user interface for the reproduction of the local device in the metaverse, wherein the user interface for the reproduction of the local device corresponds to the user interface of the local device.

Example 59 includes the subject matter of any of Examples 49-58, and wherein the local device has a user interface, wherein the plurality of instructions further cause the compute device to facilitate establishment of a user interface for the reproduction of the local device in the metaverse, wherein the user interface for the reproduction of the local device corresponds to a modification of the user interface of the local device.

Example 60 includes the subject matter of any of Examples 49-59, and wherein the plurality of instructions further cause the compute device to in response to receipt of a notification by the local device, facilitate reproduction of the notification on the reproduction of the local device in the metaverse.

Example 61 includes the subject matter of any of Examples 49-60, and wherein the plurality of instructions further cause the compute device to receive an input provided by a user of the compute device to the reproduction of the local device in the metaverse; and facilitate reproduction of the input on the local device.

Example 62 includes the subject matter of any of Examples 49-61, and wherein the plurality of instructions further cause the compute device to in response to receipt of an input to the local device, facilitate reproduction of the input on the reproduction of the local device in the metaverse.

Example 63 includes the subject matter of any of Examples 49-62, and wherein the plurality of instructions further cause the compute device to receive, from a user of the compute device, an indication that control of the reproduction of the local device in the metaverse is permitted by the one or more remote compute devices.

Example 64 includes the subject matter of any of Examples 49-63, and wherein the plurality of instructions further cause the compute device to receive an input to the reproduction of the local device in the metaverse from the one or more remote compute devices; and determine whether to pass the input to the reproduction of the local device.

Example 65 includes a system comprising one or more server compute devices to establish a metaverse, wherein a first compute device and a second compute device are connected to the metaverse; and the first compute device, wherein the first compute device comprises a processor; a memory coupled to the processor comprising a plurality of instructions that, when executed by the processor, cause the first compute device to detect a local device that is local to the first compute device; facilitate a reproduction of the local device in the metaverse; and facilitate interaction with the reproduction of the local device through the metaverse.

Example 66 includes the subject matter of Example 65, and wherein to detect the local device comprises to capture an image of the local device; and process the image to identify the local device in the image.

Example 67 includes the subject matter of any of Examples 65 and 66, and wherein to detect the local device comprises to capture sound data emitted from of the local device; and process the sound data to identify the local device.

Example 68 includes the subject matter of any of Examples 65-67, and wherein to detect the local device comprises to detect the local device over a wireless signal.

Example 69 includes the subject matter of any of Examples 65-68, and wherein the plurality of instructions further cause the first compute device to prompt, in response to detection of the local device, a user of the first compute device to accept the local device for reproduction in the metaverse.

Example 70 includes the subject matter of any of Examples 65-69, and wherein the local device has a form factor, wherein to facilitate the reproduction of the local device in the metaverse comprises to facilitate the reproduction of the local device with the form factor.

Example 71 includes the subject matter of any of Examples 65-70, and wherein the local device has a form factor, wherein to facilitate the reproduction of the local device in the metaverse comprises to facilitate the reproduction of the local device with a second form factor different from the form factor.

Example 72 includes the subject matter of any of Examples 65-71, and wherein the local device is a cell phone or a smart watch.

Example 73 includes the subject matter of any of Examples 65-72, and wherein the local device is a stylus, a keyboard, or a mouse.

Example 74 includes the subject matter of any of Examples 65-73, and wherein the local device has a user interface, wherein the one or more server compute devices are to establish a user interface for the reproduction of the local device in the metaverse, wherein the user interface for the reproduction of the local device corresponds to the user interface of the local device.

Example 75 includes the subject matter of any of Examples 65-74, and wherein the local device has a user interface, wherein the one or more server compute devices are to establish a user interface for the reproduction of the local device in the metaverse, wherein the user interface for the reproduction of the local device corresponds to a modification of the user interface of the local device.

Example 76 includes the subject matter of any of Examples 65-75, and further including the local device, wherein the local device is to receive a notification, wherein the one or more server compute devices are to reproduce the notification on the reproduction of the local device in the metaverse in response to receipt of the notification by the local device.

Example 77 includes the subject matter of any of Examples 65-76, and wherein the plurality of instructions further cause the first compute device to; receive an input provided by a user of the first compute device to the reproduction of the local device in the metaverse; and facilitate reproduction of the input on the local device.

Example 78 includes the subject matter of any of Examples 65-77, and wherein the plurality of instructions further cause the first compute device to in response to receipt of an input to the local device, facilitate reproduction of the input on the reproduction of the local device in the metaverse.

Example 79 includes the subject matter of any of Examples 65-78, and wherein the plurality of instructions further cause the first compute device to receive, from a user of the first compute device, an indication that control of the reproduction of the local device in the metaverse is permitted by the second compute device; and send, to the one or more server compute devices, an indication that control of the reproduction of the local device in the metaverse is permitted by the second compute device, wherein the one or more server compute devices are to permit control of the local device in the metaverse by the second compute device in response to receipt of the indication that control of the reproduction of the local device in the metaverse is permitted by the second compute device.

Example 80 includes the subject matter of any of Examples 65-79, and wherein the plurality of instructions further cause the first compute device to receive an input to the reproduction of the local device in the metaverse from the second compute device; and determine whether to pass the input to the reproduction of the local device.

1. A compute device comprising:
a processor;
a memory coupled to the processor comprising a plurality of instructions that, when executed by the processor, cause the compute device to:
establish a connection to a metaverse, wherein one or more remote compute devices are connected to the metaverse;
detect a local device that is local to the compute device;
facilitate a reproduction of the local device in the metaverse, wherein the reproduction can be interacted with by a user of a remote compute device in the metaverse; and
facilitate interaction with the reproduction of the local device through the metaverse.

2. The compute device of claim 1, wherein the plurality of instructions further cause the compute device to:
receive, from a user of the compute device, an indication that control of the reproduction of the local device in the metaverse is permitted by a user of the one or more remote compute devices.

3. The compute device of claim 2, wherein the plurality of instructions further cause the compute device to:
receive an input to the reproduction of the local device in the metaverse from the one or more remote compute devices; and
determine whether to pass the input to the reproduction of the local device.

4-5. (canceled)

6. The compute device of claim 1, wherein the local device has a form factor, wherein to facilitate the reproduction of the local device in the metaverse comprises to facilitate the reproduction of the local device with the form factor.

7. The compute device of claim 1, wherein the local device has a form factor, wherein to facilitate the reproduction of the local device in the metaverse comprises to facilitate the reproduction of the local device with a second form factor different from the form factor.

8. (canceled)

9. The compute device of claim 1, wherein the local device has a user interface, wherein the plurality of instructions further cause the compute device to:
facilitate establishment of a user interface for the reproduction of the local device in the metaverse, wherein the user interface for the reproduction of the local device corresponds to the user interface of the local device.

10. The compute device of claim 1, wherein the local device has a user interface, wherein the plurality of instructions further cause the compute device to:
facilitate establishment of a user interface for the reproduction of the local device in the metaverse, wherein the user interface for the reproduction of the local device corresponds to a modification of the user interface of the local device.

11. The compute device of claim 1, wherein the plurality of instructions further cause the compute device to:
receive an input provided by a user of the compute device to the reproduction of the local device in the metaverse; and
facilitate reproduction of the input on the local device.

12. The compute device of claim 1, wherein the plurality of instructions further cause the compute device to:
in response to receipt of an input to the local device, facilitate reproduction of the input on the reproduction of the local device in the metaverse.

13. One or more non-transitory computer-readable media comprising a plurality of instructions stored thereon that, when executed, causes a compute device to:
establish a connection to a metaverse, wherein one or more remote compute devices are connected to the metaverse;
detect a local device that is local to the compute device;
facilitate a reproduction of the local device in the metaverse, wherein the reproduction can be interacted with by a user of a remote compute device in the metaverse; and
facilitate interaction with the reproduction of the local device through the metaverse.

14. The one or more non-transitory computer-readable media of claim 13, wherein the plurality of instructions further cause the compute device to:
receive, from a user of the compute device, an indication that control of the reproduction of the local device in the metaverse is permitted by the one or more remote compute devices.

15. The one or more non-transitory computer-readable media of claim 14, wherein the plurality of instructions further cause the compute device to:
receive an input to the reproduction of the local device in the metaverse from the one or more remote compute devices; and
determine whether to pass the input to the local device.

16. (canceled)

17. A system comprising:
one or more server compute devices to establish a metaverse, wherein a first compute device and a second compute device are connected to the metaverse; and
the first compute device, wherein the first compute device comprises:
a processor;
a memory coupled to the processor comprising a plurality of instructions that, when executed by the processor, cause the first compute device to:
detect a local device that is local to the first compute device;
facilitate a reproduction of the local device in the metaverse; and
facilitate interaction with the reproduction of the local device through the metaverse.

18. The system of claim 17, wherein the local device has a user interface, wherein the one or more server compute devices are to establish a user interface for the reproduction of the local device in the metaverse, wherein the user interface for the reproduction of the local device corresponds to the user interface of the local device, wherein the user interface is reproduced in the metaverse at the first compute device and at the second compute device.

19. (canceled)

20. The system of claim 17, wherein the plurality of instructions further cause the first compute device to:
receive, from a user of the first compute device, an indication that control of the reproduction of the local device in the metaverse is permitted by the second compute device; and
send, to the one or more server compute devices, an indication that control of the reproduction of the local device in the metaverse is permitted by the second compute device,
wherein the one or more server compute devices are to permit control of the local device in the metaverse by the second compute device in response to receipt of the indication that control of the reproduction of the local device in the metaverse is permitted by the second compute device.

21. The compute device of claim 1, wherein the metaverse is a collective virtual shared space that enables users to interact with a computer-generated environment and with other users in real time,
wherein a user of the compute device is represented in the metaverse.

22. The compute device of claim 1, wherein the plurality of instructions further cause the compute device to:
in response to receipt of a notification by the local device, facilitate reproduction of the notification on the reproduction of the local device in the metaverse.

23. The compute device of claim 1, wherein the plurality of instructions further cause the compute device to:
prompt, in response to detection of the local device, a user of the compute device to accept the local device for reproduction in the metaverse.

24. The system of claim 17, wherein a first user is to use the first compute device, wherein a second user is to use the second compute device, wherein the second user is different from the first user,
wherein the one or more server compute devices are to facilitate interaction with the reproduction of the local device in the metaverse by a user of the second compute device.

25. The system of claim 24, wherein the metaverse is a three-dimensional virtual world, wherein the reproduction of the local device has a three-dimensional virtual form factor corresponding to a physical form factor of the local device, wherein the user of the second compute device is to interact with the reproduction of the local device through a reproduction of an input means on the three-dimensional virtual form factor and a reproduction of an output means on the three-dimensional virtual form factor.
